(19) United States
(12) Patent Application Publication
(10) Pub. No.: US 2017/0068628 A1
(43) Pub. Date: Mar. 9, 2017

(54) REDUCING ETHERNET LATENCY IN A MULTI-SERVER CHASSIS

(71) Applicant: Lenovo Enterprise Solutions (Singapore) Pte. Ltd., Singapore (SG)

(72) Inventors: Corneliu-Ilie Calciu, Bucharest (RO); Radu Mihai Iorga, Bucharest (RO)

(21) Appl. No.: 14/847,468

(22) Filed: Sep. 8, 2015

(51) Int. Cl. G06F 13/40; G06F 15/16; G06F 13/42

(52) U.S. Cl. CPC G06F 13/4022; G06F 13/4282; G06F 15/161

(57) ABSTRACT

A system includes a multi-server chassis, a midplane within the chassis, and a switching device connected to the midplane. The switching device has serial communication lanes including a lane for each of multiple server bays within the chassis, and has a network communication port for connecting to an external network. The system further comprises servers, wherein each server is received in a server bay and has a serial communication interface connected to the midplane. The midplane includes serial communication pathways, wherein each serial communication pathway provides serial communication between the serial communication interface of one of the servers and one of the serial communication lanes of the switching device. The switching device converts messages to and from an external network so that a serial expansion bus standard is used over serial communication pathways in the midplane and a network communication standard is used over the external network.

### BACKGROUND

Field of the Invention

The present invention relates to a multi-server chassis system and a network connectivity for the servers in the multi-server chassis system.

Background of the Related Art

FIG. 1 is a diagram of a prior art system 10 including a chassis 12 having multiple servers 14 communicating with a network switch 16 through a midplane 18. Each of the servers 14 has a network interface card (NIC) 15 that enables the servers 14 to communication over a network using an Ethernet network communication standard. The midplane 18 allows network communication from each NIC 15 to the network switch 16, which can redirect the network communications to one of the other servers 14 or forward the network communications to a destination on an external network 19.

In more detail, each NIC 15 converts outgoing messages on a Peripheral Component Interconnect Express (PCIe) bus to an Ethernet communication standard (see “PCIe-Eth.” 13). Each NIC 15 further includes a PHY and MAC module 17 that transmits the Ethernet communication through the midplane 18 to one of the PHY and MAC modules 20 that form an input to the network switch 16. The Ethernet communication are then passed through a switch fabric 22 to yet another PHY and MAC module 24 that transmits the Ethernet communications to the external network 19.

### BRIEF SUMMARY

One embodiment of the present invention provides a system, comprising a multi-server chassis having a plurality of server bays, a midplane secured within the multi-server chassis and aligned with the plurality of bays, and a switching device secured within the multi-server chassis and connected to the midplane. The switching device has a plurality of serial communication lanes including at least one serial communication lane for each of the plurality of server bays, and has at least one network communication port for connecting to a network beyond the multi-server chassis. The system further comprises a plurality of servers, wherein each server is received in one of the server bays and has a serial communication interface connected to the midplane. The midplane includes a plurality of serial communication pathways, wherein each serial communication pathway provides serial communication between the serial communication interface of one of the servers and one of the serial communication lanes of the switching device.

Another embodiment of the present invention provides a method, comprising a first server communicating a first message to a switching device using a serial expansion bus standard over a first serial communication pathway through a midplane, and a second server communicating a second message with the switching device using the serial expansion bus standard over a second serial communication pathway through the midplane, wherein the first server, the second server, the midplane and the switching device are secured within a multi-server chassis. The method further comprises the switching device determining whether the first message identifies an external destination outside the multi-server chassis; the switching device, in response to determining that the first message identifies an external destination, directing the first message to an egress pipeline and converting the first message from the serial expansion bus standard to a network communication standard; and the switching device transmitting the converted first message to an external network.

### BRIEF DESCRIPTION OF THE SEVERAL VIEWS OF THE DRAWINGS

FIG. 1 is a diagram of a prior art system including a multi-server chassis having multiple servers communicating with a switching device through a midplane using an Ethernet network communication standard.

FIG. 2 is a diagram of a system including a multi-server chassis having multiple servers communicating with a switching device through a midplane using a serial expansion bus standard in accordance with the present invention.

FIG. 3 is a diagram of one embodiment of the switching device of FIG. 2 in the form of an application specific integrated circuit.

FIG. 4 is a flowchart of a method in accordance with an embodiment of the present invention.

### DETAILED DESCRIPTION

One embodiment of the present invention provides a system, comprising a multi-server chassis having a plurality of server bays, a midplane secured within the multi-server chassis and aligned with the plurality of bays, and a switching device secured within the multi-server chassis and connected to the midplane. The switching device has a plurality of serial communication lanes including at least one serial communication lane for each of the plurality of server bays, and has at least one network communication port for connecting to a network beyond the multi-server chassis. The system further comprises a plurality of servers, wherein each server is received in one of the server bays and has a serial communication interface connected to the midplane. The midplane includes a plurality of serial communication pathways, wherein each serial communication pathway provides serial communication between the serial communication interface of one of the servers and one of the serial communication lanes of the switching device.

The multi-server chassis has a plurality of server bays for selectively receiving and supporting the operation of a plurality of servers, such as blade servers. The midplane may provide electrical power and network communications to each server that is secured into one of the server bays. Accordingly, the midplane may be connected to a power supply, management module and one or more switching device. The switching device may be secured directly to the midplane, or the switching device may be included in an input output module received in a socket connector on the midplane. The servers, midplane and switching device are preferably secured with the same multi-server chassis so that the path length for the serial communication from any one of the servers to the switching device provides for reliable communication of data. For example, a path length of less than about two feet is known to suitable for serial communication using a Peripheral Component Interconnect Express (PCIe) communication standard, although the invention is not limited to this distance.

The switching device is converts the serial communication received from the each server to a network communication standard so that messages may be transmitted to an identified destination on an external network, such as a local area network (LAN), wide area network (WAN) or a global communications network, such as the Internet. Conversely, messages received from the external network and identifying one of the servers as a destination, are converted by the switching device from the network communication standard to the serial communication standard before directing the message to the identified destination server. The serial communication may, without limitation, follow or implement a serial expansion bus standard, such as Peripheral Component Interconnect Express (PCIe). The network communication standard may, without limitation, follow or implement an Ethernet communication standard.

Embodiments of the switching device may include an application specific integrated circuit (ASIC) that provides a PCIe to Ethernet bridge. For example, the application specific integrated circuit may include, for each serial communication lane, a receiver direct memory access (DMA) engine coupled to an ingress pipeline and a transmitter direct memory access (DMA) engine coupled to a port egress pipeline. Still further, the application specific integrated circuit may include a memory management unit (MMU) and switching logic module coupled between each serial communication lane and the at least one network communication port, such as at least one media access control port. Embodiments of the application specific integrated circuit may further include Ethernet logic, such as flow control, media access control address encapsulation, error detection, validation, and clock domain synchronization. Optionally, the switching device may include at least two of the application specific integrated circuits in order to provide redundancy.

Another embodiment of the present invention provides a method, comprising a first server communicating a first message to a switching device using a serial expansion bus standard over a first serial communication pathway through a midplane, and a second server communicating a second message with the switching device using the serial expansion bus standard over a second serial communication pathway through the midplane, wherein the first server, the second server, the midplane and the switching device are secured within a multi-server chassis. The method further comprises the switching device determining whether the first message identifies an external destination outside the multi-server chassis; the switching device, in response to determining that the first message identifies an external destination, directing the first message to an egress pipeline and converting the first message from the serial expansion bus standard to a network communication standard; and the switching device transmitting the converted first message to an external network.

Embodiments of the method may include any one or more aspect of any of the foregoing embodiments of the system of the present invention. For example, the servers may be blade servers. Separately, and without limitation, the serial expansion bus standard may be Peripheral Component Interconnect Express, and the network communication standard may be Ethernet.

Another embodiment of the method may further comprise the switching device determining whether the second message identifies an external destination outside the multi-server chassis; the switching device, in response to determining that the second message identifies an external destination, directing the second message to the egress pipeline and converting the second message from a serial expansion bus standard to a network communication standard; and the switching device transmitting the converted second message to the external network.

Yet another embodiment of the method may further comprise the switching device receiving a third message from the external network, converting the third message from the network communication standard to the serial expansion bus standard, and determining whether the third message identifies the first server as a destination for the third message. The method may further comprise the switching device, in response to determining that the first server is identified as the destination for the third message, directing the third message to an ingress pipeline for the first server. Then, the switching device may transmit the converted third message from the ingress pipeline to the first server.

Embodiments of the present invention may be implemented to reduce latency while using Ethernet as a connecting technology for blade servers and also to reduce power consumption of a blade server system. Rather that each blade server having its own Ethernet controller, each blade server has a PCIe interface that is connected directly to a switching device that provides a PCIe to Ethernet bridge. Latency is reduced because two MAC controllers and two PHY blocks (i.e., one MAC and one PHY for the Ethernet card of each server, and one MAC and one PHY for each switch port connecting the servers) are eliminated by integrating the PCIe to Ethernet bridge inside the switching device.

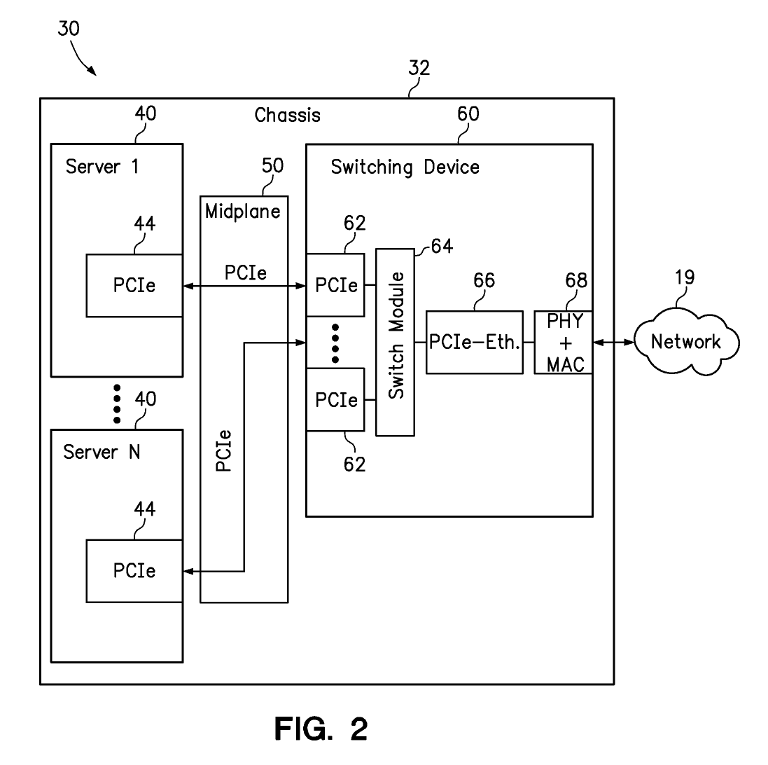

FIG. 2 is a diagram of a system 30 including a multi-server chassis 32 having multiple servers 40 (Server 1 to Server N) communicating with a switching device 60 through a midplane 50 using a serial expansion bus standard in accordance with the present invention. Specifically, each server 40 includes a Peripheral Component Interconnect Express (PCIe) expansion bus port 44 that is coupled to the midplane 50 for communication with a PCIe port 62 on the switching device 60. There is one PCIe port 62 for each of the servers 40. Messages on the PCIe ports 62 are controllably passed through the switch module 64 to a destination. If a message from one of the servers 40 identifies a destination that is one of the other servers 40, then the switch module 64 forwards the message to the destination server without converting the message to an Ethernet communication. Conversely, if a message from one of the servers 40 identifies a destination on the external network 19, then the switch module 64 sends the message to a “PCIe-Eth.” module 66 for conversion from a PCIe expansion bus communication standard to an Ethernet communication standard. The switching device 60 includes a PHY and MAC module 68 that then transmits the Ethernet communication to the external network 19. It should be recognized that the switching device 60 can direct messages incoming from the network to any one of the servers 40 that the message identifies as a destination. Accordingly, the module 66 converts the message from Ethernet to PCIe before the switch module 64 directs the message to the destination server 40.

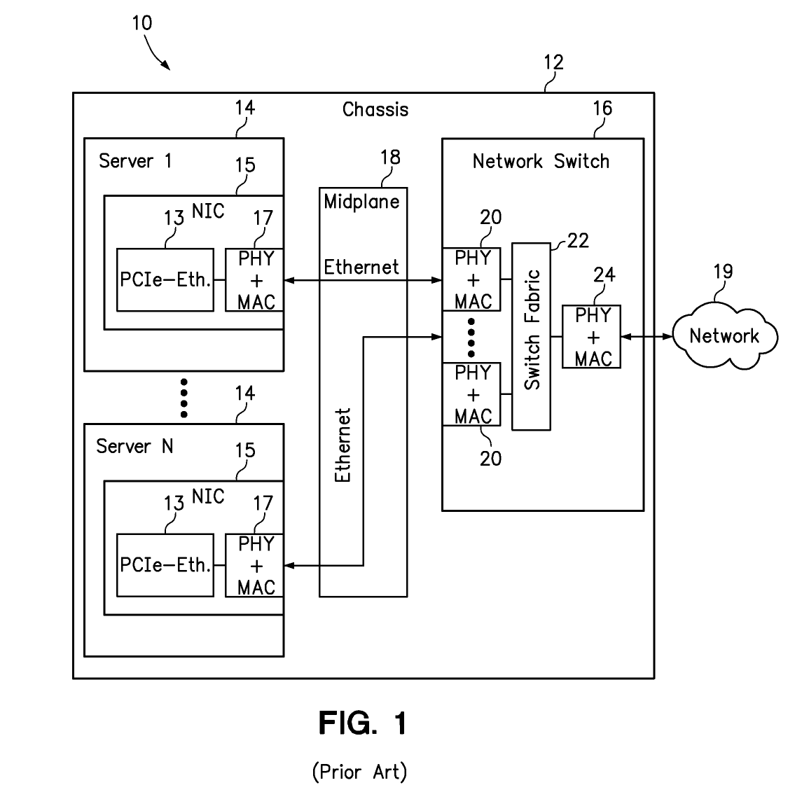

The system 30 experiences reduced latency, relative to the prior art system of FIG. 1, due to the elimination of two “PHY and MAC” modules in the communication pathway from a server 40 to the network 19. The system 30 also experiences reduced power consumption as a result of eliminating two “PHY and MAC” modules for every server 40 in the chassis 32. Still further, the system 30 presents fewer interoperability issues between the server and the switching device.

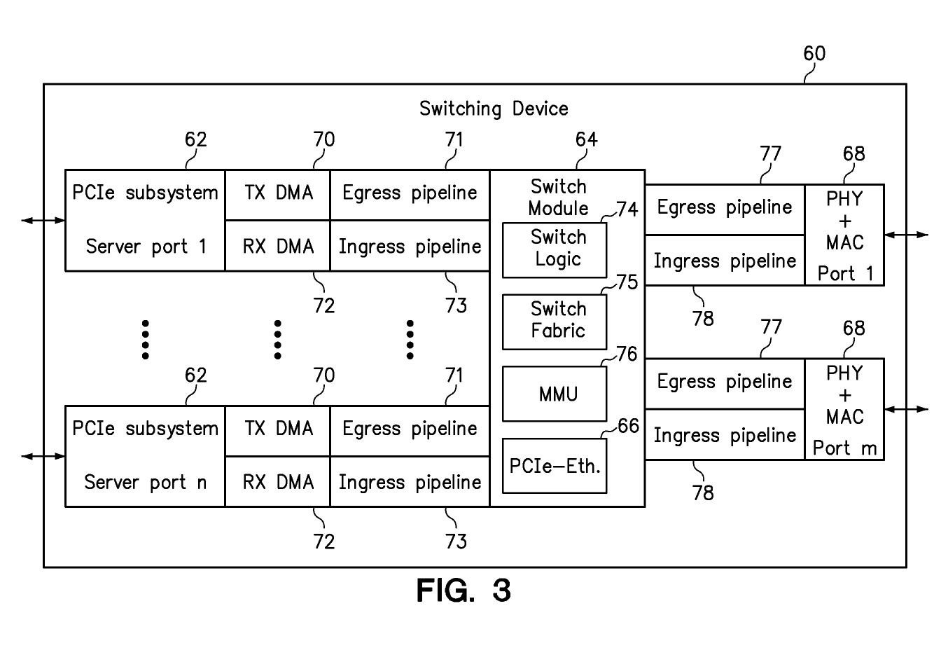

FIG. 3 is a diagram of one embodiment of the switching device 60 of FIG. 2 in the form of an application specific integrated circuit (ASIC) that places all of the switching and PCIe to Ethernet functionality in a single system on a chip (“SOC”). The switching device 60 includes a PCIe port 62 (one of Server Port 1 to Server Port N) for each server that may be connected to the switching device 60. Each PCIe port 62 is provided with a transmitting direct memory access (TX DMA) engine 70 connected with a port egress pipeline 71 and a receiving direct memory access (RX DMA) engine 72 connected with a port ingress pipeline 73. The TX DMA engine 70 is a hardware block inside the switching device 60 that will copy a packet to memory (RAM) on a server 40 from packet memory buffers of the port egress pipeline 71 allocated by the Memory Management Unit (MMU) 76 of the switch module 64. The RX DMA engine 72 is a hardware block inside the switching device 60 that will copy a packet from memory (RAM) of the server 40 into packet memory buffers of the ingress pipeline 73 allocated by the MMU 76.

The switch module 64 further includes switch logic 74 that controls the switch fabric 75, and PCIe to Ethernet logic 66. The switch module 64 may also include any or all of the Ethernet card logic that may have been previously performed by a network interface card (NIC 15; see FIG. 1) in each blade server enclosure. Examples of the Ethernet card logic that may be integrated in the switching device 60 include, without limitation, flow control, MAC encapsulation, CRC computation and validation, and clock domain synchronization.

On the network side, the switching device 60 further includes an egress pipeline 77 and an ingress pipeline 78 between the switch module 64 and a PHY and MAC module 68 for transmitting and receiving packets from an external network. For example, the PHY and MAC module 68 may establish an Ethernet 1G/10G/40G interface. As shown, the switching device 60 includes an optional second Ethernet interface (egress pipeline 77, ingress pipeline 78, PHY and MAC module 68) to provide redundancy or increase network bandwidth. Optionally, the switching device 60 may be secured directly to the midplane or secured to a separate printed circuit board in communication with the midplane in order to support replacement and upgrades. In a further option, two or more of the switching devices 60 may be installed in the system 30 (see FIG. 2) for the purpose of redundancy at the system level.

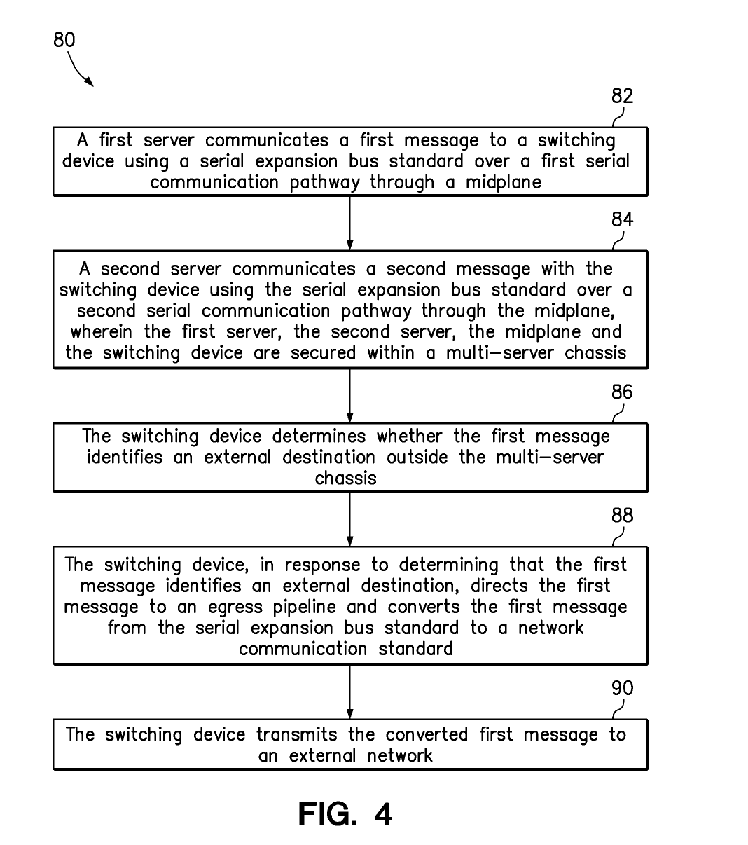

FIG. 4 is a flowchart of a method 80 in accordance with an embodiment of the present invention. In step 82, a first server communicates a first message to a switching device using a serial expansion bus standard over a first serial communication pathway through a midplane. In step 84, a second server communicates a second message with the switching device using the serial expansion bus standard over a second serial communication pathway through the midplane, wherein the first server, the second server, the midplane and the switching device are secured within a multi-server chassis. In step 86, the switching device determines whether the first message identifies an external destination outside the multi-server chassis. In step 88, the switching device, in response to determining that the first message identifies an external destination, directs the first message to an egress pipeline and converts the first message from the serial expansion bus standard to a network communication standard. Then, in step 90, the switching device transmits the converted first message to an external network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a multi-server chassis having a plurality of server bays;
a midplane secured within the multi-server chassis and aligned with the plurality of bays;
a switching device secured within the multi-server chassis and connected to the midplane, wherein the switching device includes a plurality of serial communication lanes including at least one serial communication lane for each of the plurality of server bays, and wherein the switching device has at least one network communication port for connecting to a network beyond the multi-server chassis; and
a plurality of servers, each server received in one of the server bays and having a serial communication interface connected to the midplane, wherein the midplane includes a plurality of serial communication pathways, wherein each serial communication pathway provides serial communication between the serial communication interface of one of the servers and one of the serial communication lanes of the switching device.

2. The system of claim 1, wherein the switching device converts the serial communication received from the each server to a network communication standard.

3. The system of claim 2, wherein the serial communication follows a serial expansion bus standard.

4. The system of claim 3, wherein the serial expansion bus standard is Peripheral Component Interconnect Express.

5. The system of claim 2, wherein the network communication standard is Ethernet.

6. The system of claim 1, wherein the servers are blade servers.

7. The system of claim 1, wherein the switching device is secured directly to the midplane.

8. The system of claim 1, wherein the switching device is included in an input output module received in a socket connector on the midplane.

9. The system of claim 1, wherein the switching device includes an application specific integrated circuit that provides a PCIe to Ethernet bridge.

10. The system of claim 9, wherein the application specific integrated circuit includes, for each serial communication lane, a receiver direct memory access engine coupled to an ingress pipeline and a transmitter direct memory access engine coupled to a port egress pipeline.

11. The system of claim 10, wherein the application specific integrated circuit includes a memory management unit and switching logic module coupled between each serial communication lane and the at least one network communication port.

12. The system of claim 11, wherein the at least one network communication port is at least one media access control port.

13. The system of claim 9, wherein the application specific integrated circuit includes Ethernet logic selected from flow control, media access control address encapsulation, error detection, validation, and clock domain synchronization.

14. The system of claim 9, wherein the switching device include at least two of the application specific integrated circuits to provide redundancy.

15. A method, comprising:
a first server communicating a first message to a switching device using a serial expansion bus standard over a first serial communication pathway through a midplane;
a second server communicating a second message with the switching device using the serial expansion bus standard over a second serial communication pathway through the midplane, wherein the first server, the second server, the midplane and the switching device are secured within a multi-server chassis;
the switching device determining whether the first message identifies an external destination outside the multi-server chassis;
in response to determining that the first message identifies an external destination, directing the first message to an egress pipeline and converting the first message from the serial expansion bus standard to a network communication standard; and
the switching device transmitting the converted first message to an external network.

16. The method of claim 15, wherein the serial expansion bus standard is Peripheral Component Interconnect Express, and wherein the network communication standard is Ethernet.

17. The method of claim 15, wherein the servers are blade servers.

18. The method of claim 15, further comprising:
the switching device determining whether the second message identifies an external destination outside the multi-server chassis;
in response to determining that the second message identifies an external destination, directing the second message to the egress pipeline and converting the second message from a serial expansion bus standard to a network communication standard; and
the switching device transmitting the converted second message to the external network.

19. The method of claim 15, further comprising:
the switching device receiving a third message from the external network;
the switching device converting the third message from the network communication standard to the serial expansion bus standard;
the switching device determining whether the third message identifies the first server as a destination for the third message;
in response to determining that the first server is identified as the destination for the third message, directing the third message to an ingress pipeline for the first server; and
the switching device transmitting the converted third message from the ingress pipeline to the first server.
